(19) United States
(12) Patent Application Publication
(10) Pub. No.: US 2002/0039388 A1
(43) Pub. Date: Apr. 4, 2002

(54) High data-rate powerline network system and method

(76) Inventors: Kevin J. Smart, Bountiful, UT (US); Trenton D. Stoddard, Sandy, UT (US); Dan B. Haab, Springville, UT (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/794,761

(22) Filed: Feb. 27, 2001

Related U.S. Application Data
(60) Provisional application No. 60/185,891, filed on Feb. 29, 2000.

(51) Int. Cl. H04L 27/28

(52) U.S. Cl. 375/260

(57) ABSTRACT

A powerline network physical layer that allows multiple nodes to communicate digital data at high speed, with low error rates, using electrical powerlines in a home or office is described. The physical layer provides multiple channels by using Frequency Division Multiplexing (FDM). Each FDM channel is independent and separately modulated to carry data using Differential Binary Phase Shift Keying (DBPSK) or Differential Quadrature Phase Shift Keying (DQPSK). The error rate on each FDM channel is monitored and the separate channel are used according to an error rate criterion. If a channel is presenting an error rate that is too high, the channel is either disabled, ignored, or reconfigured into a reduced-capacity mode that provides an acceptable error rate.

### RELATED APPLICATIONS

The present application claims priority benefit of U.S. Provisional Application No. 60/185891, filed Feb. 29, 2000, and titled “HIGH DATA-RATE POWERLINE NETWORK SYSTEM AND METHOD.”

### FIELD OF THE INVENTION

The present invention relates to techniques for using the existing electrical powerlines in a home or office as a network medium to carry high-speed data traffic.

### BACKGROUND OF THE INVENTION

The widespread availability of computers, especially personal computers, has generated a rapid increase in the number of computer networks. Networking two or more computers together allows the computers to share information, file resources, printers, etc. Connecting two or more personal computers and printers together to form a network is, in principle, a simple task. The computers and printers are simply connected together using a cable, and the necessary software is installed onto the computers. In network terminology, the cable is the network medium and the computers and printers are the network nodes. Unfortunately, in practice, creating a computer network is often not quite as simple as it sounds. Typically, a user will encounter both software and hardware problems in attempting to configure a computer network.

When configuring a network in a home or small office, users often encounter hardware difficulties insomuch as it is usually necessary to install a network cable to connect the various network nodes. In a home or office environment, it can be very difficult to install the necessary cabling when the computers are located in different rooms or on different floors. Network systems that use radio or infrared radiation are known, but such systems are subject to interference and government regulation, and thus are far less common than systems that rely on a physical connection such as a wire or cable.

Virtually all residential and commercial buildings in the U.S. are wired with telephone lines and powerlines. Theoretically, either the telephone lines or the powerlines could be used as the network medium. Telephone lines are less desirable than powerlines because there are usually fewer telephone outlets than power outlets. This is especially true in homes.

Unfortunately, the physical construction of typical powerlines is not as good as other wiring types, such as twisted pair or coaxial cable, for carrying the high frequencies usually associated with high data rates. Moreover, the electrical signal environment of a typical powerline can be characterized as very noisy. The powerlines carry noise generated by motors, switching transients, and the like. The powerlines also act as receiving antennas and carry Radio Frequency (RF) noise picked up from lightning, radio stations, etc. Finally, the powerlines do not present a constant impedance as the switching of loads such as lights, appliances, and the like creates ever changing variations in impedance. These noise and impedance problems have heretofore prohibited the use the electrical powerlines as a transmission medium for high-speed network data.

### SUMMARY OF THE INVENTION

The present invention solves these and other problems by providing a powerline network physical layer that allows multiple nodes to communicate digital data at high speed, with low error rates, using electrical powerlines in a home or office. The network nodes can include: “intelligent” devices, such as personal computers, printer controllers, alarm system controllers, and the like; “non-intelligent” devices such as appliances, outdoor lighting systems, alarm sensors, and the like; or both.

In one embodiment, groups of bits are encoded as symbols, each symbol having a symbol time. The duration of each transmitted symbol (symbol time) is programmable. Relatively longer symbol times (resulting in lower data rates) are used during time periods when the powerline is noisy. Noise on a powerline (or other communication medium) is often characterized by a combination of relatively constant noise (e.g., background noise) and relatively non-constant noise (e.g., noise bursts, such as, for example, the noise bursts produced by the sparking action of brushes in an electric motor). The relatively longer symbol times are programmed to be long enough to provide better signal-to-noise ratio against relatively constant noise, but still short enough to allow blocks of symbols (i.e. packets) to be transmitted in-between noise bursts. Longer symbol times also allow the channel to ring-down to an acceptable level (ringing on the channel can be caused by, for example, channel bandwidth or reflections on the channel). Relatively shorter symbol times (resulting in higher data rates) are used with the powerline is less noisy and thus able to support a higher data rate.

In one embodiment, multiple independent channels are multiplexed onto a single powerline. The use of multiple channels provides higher aggregate data rates (greater throughput) during time periods when the noise spectrum on the powerline permits use of several channels. The use of multiple independent channels also provides higher reliability, and lower error rates, especially during time periods when the noise spectrum on the powerline prohibits the use of one or more of the channels.

In one embodiment the physical layer provides multiple channels by using Frequency Division Multiplexing (FDM). Each FDM channel is independent and separately modulated to carry data. In one embodiment, each FDM channel is modulated using Differential Binary Phase Shift Keying (DBPSK) or Differential Quadrature Phase Shift Keying (DQPSK). DBPSK and DQPSK are relatively robust in the presence of noise and provide relatively low error rates. In one embodiment, orthogonal FDM (OFDM) is used.

In one embodiment, the error rate on each FDM channel is monitored and channels are switched in and out (enabled and disabled) according to an error rate criterion. If a channel is presenting an error rate that is too high, the channel is disabled for regular data traffic until the error rate of that channel improves. In one embodiment, a channel that is presenting an unacceptably high error rate is not disabled for data traffic, but rather, the channel is operated in a reduced capacity mode that provides an acceptable error rate. In one embodiment, a reduced-capacity mode includes operating the channel at a lower data rate. In one embodiment, a reduced-capacity mode includes operating the channel using relatively longer symbol times. In one embodiment, a reduced-capacity mode includes operating the channel using relatively more error detection and correction bits.

In one embodiment, a transmitter sends the same data on several predetermined channels, and the receiver is a single channel receiver that hunts for the signal by looking for the best channel and receiving the data on that channel.

One embodiment includes a method for demodulating data for transmission on a noisy channel by selecting a symbol time based on the noise. The selected symbol time is used to control a delay tap on a programmable delay and to select a decimation rate of an output decimator. A modulated signal is applied to an input of the programmable delay and an output of the programmable delay is provided to an input of the output decimator.

One embodiment includes a method for symbol-synchronization of a receiver having programmable symbol times. A received signal is demodulated using a programmed symbol time to produce a demodulator output. The demodulator output is then correlated against a known waveform. Symbol synchronization is selected by selecting a correlation peak.

One embodiment includes a phase-to-phase coupling apparatus for coupling data from a first phase of a powerline to a second phase line of the powerline. The phase-to-phase coupling apparatus includes a coupler connected between two or more phases of the powerline.

One embodiment includes a computer power supply that includes a powerline network interface. One embodiment includes a power supply that includes a coupler for coupling modulated data onto and off of a powerline.

### BRIEF DESCRIPTION OF THE DRAWINGS

Aspects, features, and advantages of the present invention will be more apparent from the following particular description thereof presented in conjunction with the following drawings, wherein:

FIG. 1 is a schematic diagram of the electrical powerline wiring in a typical home or small office and a networking system that use the powerlines as the network medium.

FIG. 2 (consisting of FIGS. 2A, 2B, and 2C) is a diagram showing embodiments of a powerline network module.

FIG. 3 is a functional block diagram of a powerline network module.

FIG. 4 is a block diagram of an N-channel transmitter suitable for use with the powerline network module shown in FIG. 3.

FIG. 5 is a block diagram of an N-channel receiver suitable for use with the powerline network module shown in FIG. 3.

FIG. 6 is a block diagram of an N-channel transmitter that uses differential PSK modulation, and that is suitable for use with the powerline network module shown in FIG. 3.

FIG. 7A shows a state transition diagram for DBPSK modulation.

FIG. 7B shows state transition diagram for DQPSK modulation.

FIG. 8 is a block diagram of a digital sinusoid generator suitable for use with the powerline network module shown in FIG. 3.

FIG. 9 is a block diagram of a digital N-channel receiver suitable for use with the powerline network module shown in FIG. 3.

FIG. 10A is a block diagram of a one-bit digital sampler suitable for use with the digital receiver shown in FIG. 9.

FIG. 10B is a block diagram of a two-bit digital sampler suitable for use with the digital receiver shown in FIG. 9.

FIG. 11 is a block diagram of a digital demodulator suitable for use with the digital receiver shown in FIG. 9.

FIG. 12 is a block diagram of a digital N-channel receiver that samples groups of channels.

FIG. 13 is a logical diagram of a layered network system.

FIG. 14A is an illustration of a coupling device for coupling data between different phases of a multi-phase power system.

FIG. 14B is a schematic of the coupling device show in FIG. 14A.

In the drawings, the first digit of any three-digit number generally indicates the number of the figure in which the element first appears. Where four-digit reference numbers are used, the first two digits indicate the figure number.

### DETAILED DESCRIPTION

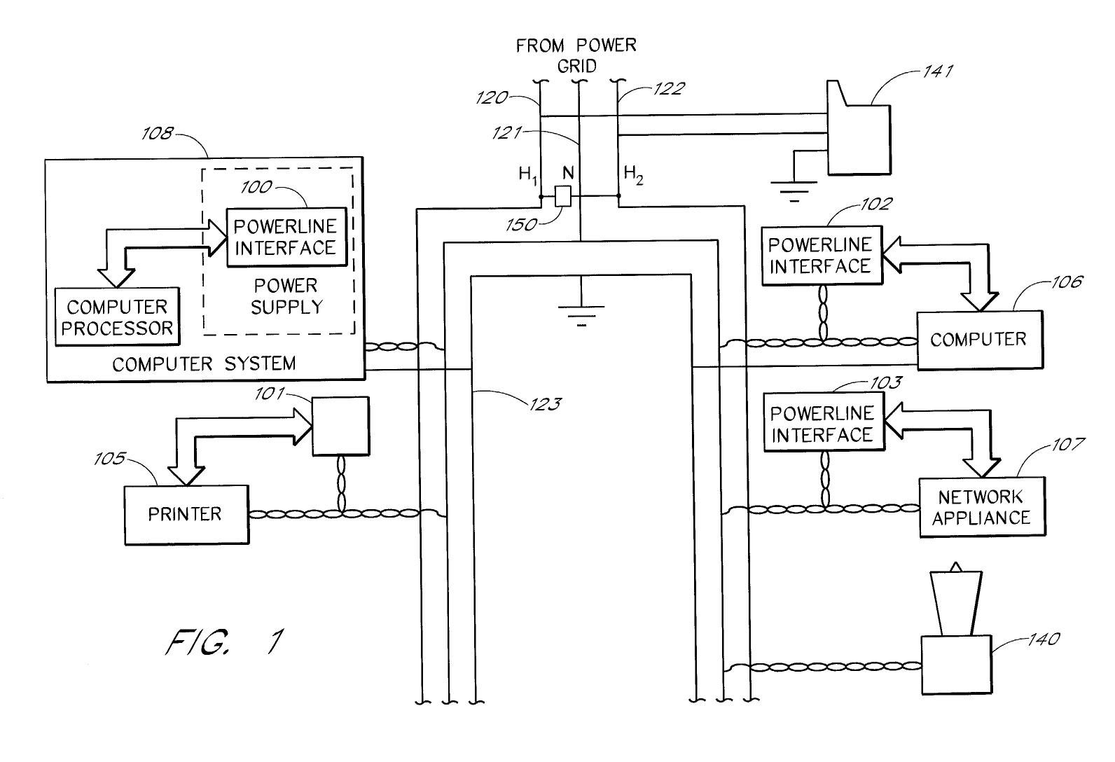

FIG. 1 is a schematic diagram of the electrical powerline wiring in a typical home or small office and a networking system that uses the electrical powerlines as the network medium. Power is received from an external power grid as the power grid on a first hot wire 120, a second hot wire 122, and a neutral wire 121. The hot wires 120 and 122 carry an alternating current at 60 Hz (hertz) at a voltage that is 110 volts RMS with respect to the neutral wire 121. The hot wires 120 and 122 are 180 deg. out of phase with respect to each other, such that the voltage measured between the first hot wire 120 and the second hot wire 122 is 220 volts RMS.

The first hot wire 120 and the second hot wire 122, along with a ground wire 123 (safety ground), are provided to large appliances such as an electric dryer 141 (and electric ranges, electric ovens, central air conditioning systems and the like). Only one of the hot wires 120, 122 is provided to smaller appliances, lights, computers, etc. For example, as shown in FIG. 1, the second hot wire 122 and the neutral wire 121 are provided to a blender 140.

The first hot wire 120, the neutral wire 121, and the ground wire 123 are provided to a power input of a computer 108. The computer 108 includes a powerline network module 100. The powerline network module 100 couples data between the electrical powerline and a network port in the computer 108, thereby allowing the computer 108 to use the powerline as a network medium. In one embodiment, the powerline network module 100 is configured as part of a computer power supply in the computer 108.

In an alternate embodiment, the powerline network module 100 is configured on a circuit board, such as a plug-in board or on a motherboard in the computer 108. In one embodiment, a power supply of the computer 108 includes a power supply coupler to couple modulated powerline network data onto and off of the powerline. In one embodiment, the power supply coupler provides the modulated data to a motherboard or plug-in board while isolating the motherboard or plug-in board from the dangers presented by the high-voltage 60 Hz (or 50 Hz) signals on the powerline.

The first hot wire 120, the neutral wire 121, and the ground wire 123 are provided to a power input of a printer 105. The first hot wire 120 and the neutral wire 121 are also provided to a powerline data port of a powerline network module 101. A data port on the powerline network module 101 is provided to a data port on the printer 108.

The second hot wire 122, the neutral wire 121, and the ground wire 123 are provided to a power input of a computer 106. The second hot wire 122 and the neutral wire 121 are provided to a powerline data port of a powerline network module 102. A data port on the powerline network module 102 is provided to a network data port on the computer 106.

The second hot wire 122, the neutral wire 121, and the ground wire 123 are provided to a power input of a networked device 107. The second hot wire 122 and the neutral wire 121 are provided to a powerline data port of a powerline network module 103. A data port on the powerline network module 103 is provided to a network data port on the device 107. The device 107 can be any networked appliance or device in the home or office, including, for example, an alarm system controller, an alarm system sensor, a controllable light, a controllable outlet, a networked kitchen appliance, a networked audio system, a networked television or other audio-visual system, etc.

The computers 108 and 106, the printer 105, and the networked device 107 communicate using the electrical powerlines (the hot wires 120, 122, and the neutral wire 121). The powerline network modules 100-103 receive network data, modulate the data into a format suitable for the powerline, and couple the modulated data onto the powerline. The powerline network modules also receive modulated data from the powerlines, and demodulate the data.

The hot wires 120 and 122 are separate circuits that are usually only connected at a power distribution transformer or large appliance (such as the dryer 141). Nevertheless, there is typically enough crosstalk between these two circuits such that data signals on the first hot line 120 are coupled onto the second hot line 122 and vice versa. Thus, devices connected to the first hot wire 120 (the computer 108, for example) can communicate with devices connected to the second hot wire 122 (the computer 106, for example). An optional coupling network 150 can be provided between the first hot wire 120 and the second hot wire 122 to improve the coupling of high (data-carrying) frequencies between the two hot wires.

Devices such as the blender 140 and the dryer 141 introduce noise onto the powerlines. This noise includes motor noise, switching transients, etc. The network modules 100-103 are configured to provide an acceptable maximum data error rate in the presence of this noise.

A powerline interface such as the powerline interfaces 100-103 can be connected between a first hot wire (e.g. the hot wire 120 or the hot wire 122) and any other wire in the powerline system including the neutral wire 121 and the ground wire 123. Typically, a powerline interface connected to a 110-volt device is connected between a first hot wire (either the hot wire 120 or the hot wire 122) and the neutral wire 121. In one embodiment, a powerline interface connected to a 220-volt device (such as, for example, the dryer 141) is connected between the hot wire 120 and the hot wire 122.

FIG. 1 shows a typical household wiring system found in the United States. One skilled in the art will recognize that the powerline interfaces 100-103 can be use with other power distribution system, including 50 hertz single-phase 220-volt system common in Europe and other parts of the world. The powerline interfaces 110-130 can also be used with high-voltage power distribution systems used to deliver power to homes, cities, etc. The powerline interfaces 100-103 can also be used with multi-phase power distribution system, such as, for example, 3-phase systems.

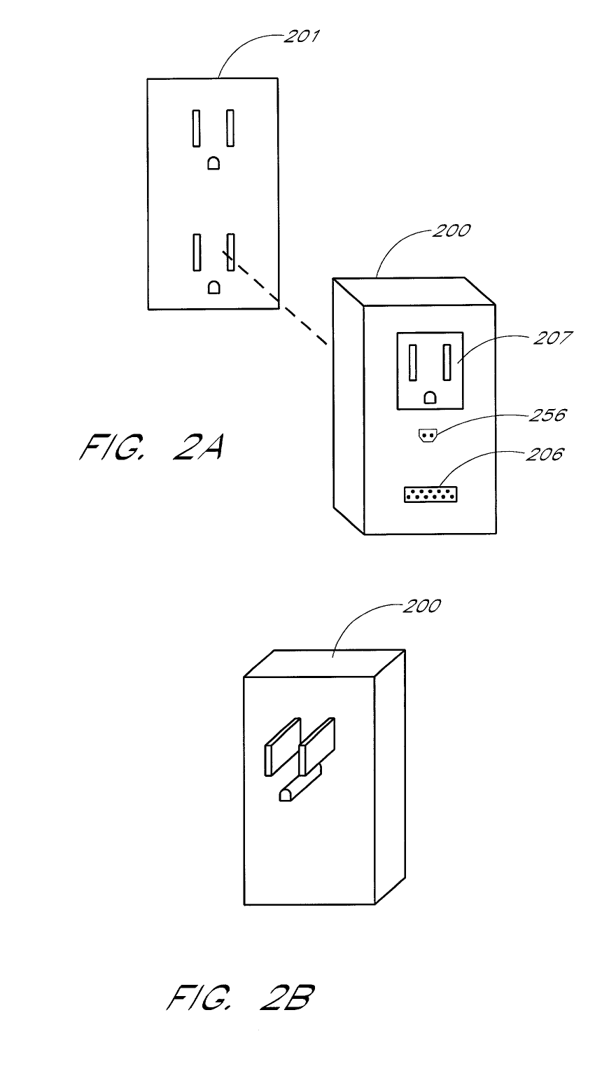

FIGS. 2A and 2B show front and rear views (respectively) of one embodiment of a powerline network module 200 (suitable for use as the network modules 101-103 shown in FIG. 1). The module 200 is configured to plug into a standard three-prong electrical outlet, thereby connecting the module to hot, neutral, and ground wires in the powerline. The module 200 includes a standard three-prong socket 207 and a network connector 206. The connectors 206 and 256 (and the signals provided at the connectors) can be configured for any type of data bus, including, for example, a parallel port, a Universal Serial Bus (USB), Ethernet, FireWire, etc.

FIG. 2C shows a powerline network module 260 that is suitable for use as the network modules 101-103 shown in FIG. 1. The module 260 includes a plug portion 251 and an interface portion 250. The plug portion is adapted to plug into a wall socket using prongs 253. The plug portion includes an AC socket 252 to allow electrical devices to use the same AC outlet that the plug portion 251 is plugged into. The plug portion 250 is connected to the interface portion 250 by an cable 254. The interface portion is provided with one or more computer interface connectors, such as, for example a parallel port connector 255 and/or a USB connector 256.

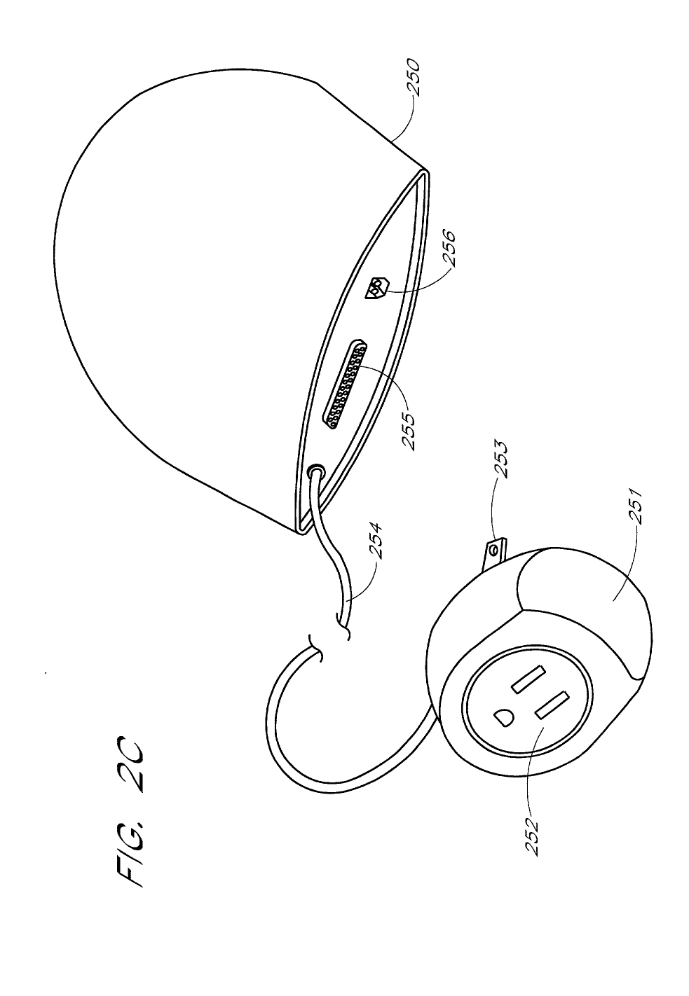

FIG. 3 is a functional block diagram of the powerline network module 200 (and the network module 100). In the module 200 (and the module 100), the hot and neutral lines are provided to a powerline port of an Analog Front End (AFE) 316, and to the hot and neutral lines of the socket 207. The ground line is provided to the ground line of the socket 207. A data output from the AFE 316 is provided to a data input of a receiver 314. One or more data streams from the receiver 314 are provided via a data bus 312 to a data input of an interface 302.

One or more data streams from the interface 302 are provided via a data bus 306 to a data input of a transmitter 308. A data output from the transmitter 308 is provided to a data input of the AFE 316. A control output 304 from the interface 302 is provided to a control input of the transmitter 308. A control output 310 from the interface 302 is provided to a control input of the receiver 314. A transmitter control output from the interface 302 is provided to a control input of the transmitter 308, and a receiver control output from the interface 302 is provided to a control input of the receiver 314. A data bus 301 is provided between the network connector 320 and the interface 302.

The interface 302, the transmitter 308, the receiver 314, and the AFE 316 together comprise a powerline network interface 300. One skilled in the art will recognize that the powerline network interface 300 can be used independently of the powerline network module 200. The powerline network interface 300 can be built into any electrical device, including, for example, a computer, an appliance, an electrical outlet, an electrical power switch, an audio device, a video device, an alarm system, a central heating/cooling system, etc. In a computer, the powerline network interface 300 can be configured on a motherboard, in a computer power-supply, or on a plug-in adapter card (e.g., a PCI card, ISA card, etc).

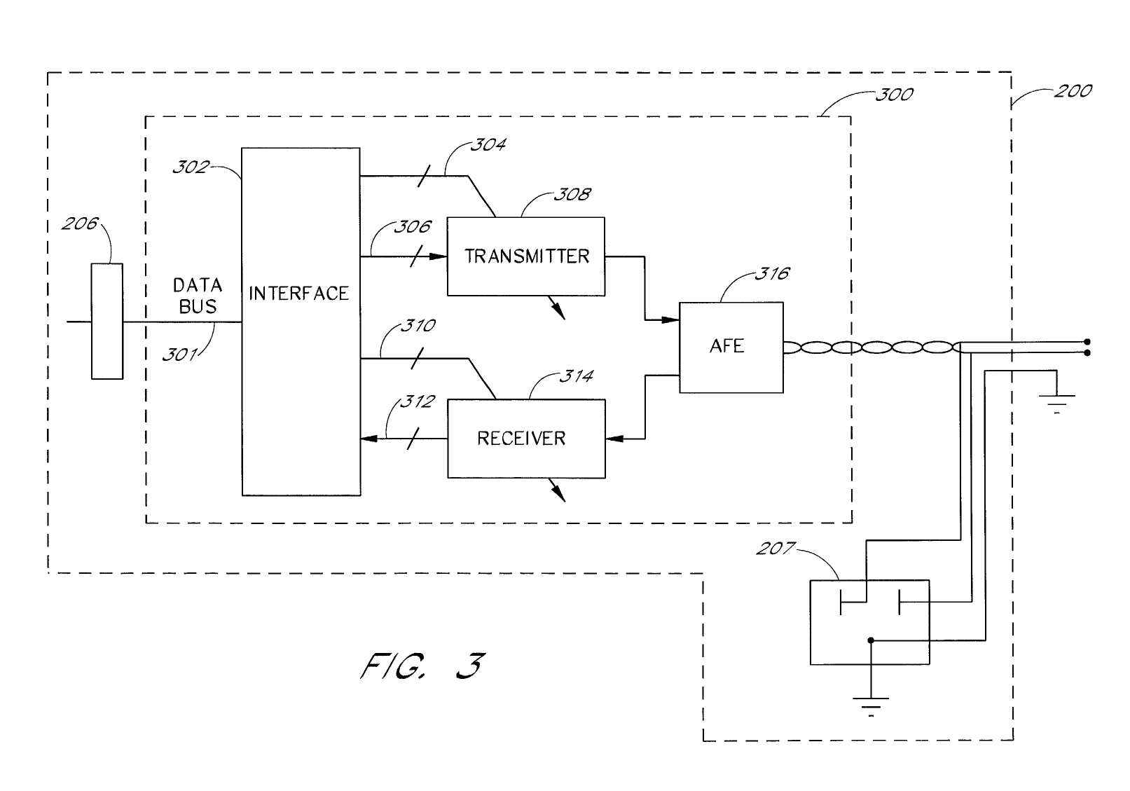

FIG. 4 is a block diagram of an N-channel transmitter 400. The transmitter 400 is one embodiment of the transmitter 308 shown in FIG. 3. In the transmitter 400, the input data stream 306 is provided to a stream input of a data demultiplexer 402. A first stream output 431 from the data demultiplexer 402 is provided to a data stream input of a channel modulator 404. A second stream output 432 from the data demultiplexer 402 is provided to a data stream input of a channel modulator 405. An N-th stream output 433 from the data demultiplexer 402 is provided to a data stream input of a channel modulator 406.

The channel modulator 404 includes a local oscillator 408 and a data modulator 414. A carrier output from the local oscillator 408 is provided to a carrier input of the data modulator 414. The output stream 431 is provided to a data input of the data modulator 414. A modulated signal output 441 is provided by the data modulator 414 as an output of the channel modulator 404.

The channel modulator 405 includes a local oscillator 409 and a data modulator 415. A carrier output from the local oscillator 409 is provided to a carrier input of the data modulator 415. The output stream 432 is provided to a data input of the data modulator 415. A modulated signal output 442 is provided by the data modulator 415 as an output of the channel modulator 405.

The channel modulator 406 includes a local oscillator 410 and a data modulator 416. A carrier output from the local oscillator 410 is provided to a carrier input of the data modulator 416. The output stream 433 is provided to a data input of the data modulator 416. A modulated signal output 443 is provided by the data modulator 416 as an output of the channel modulator 406.

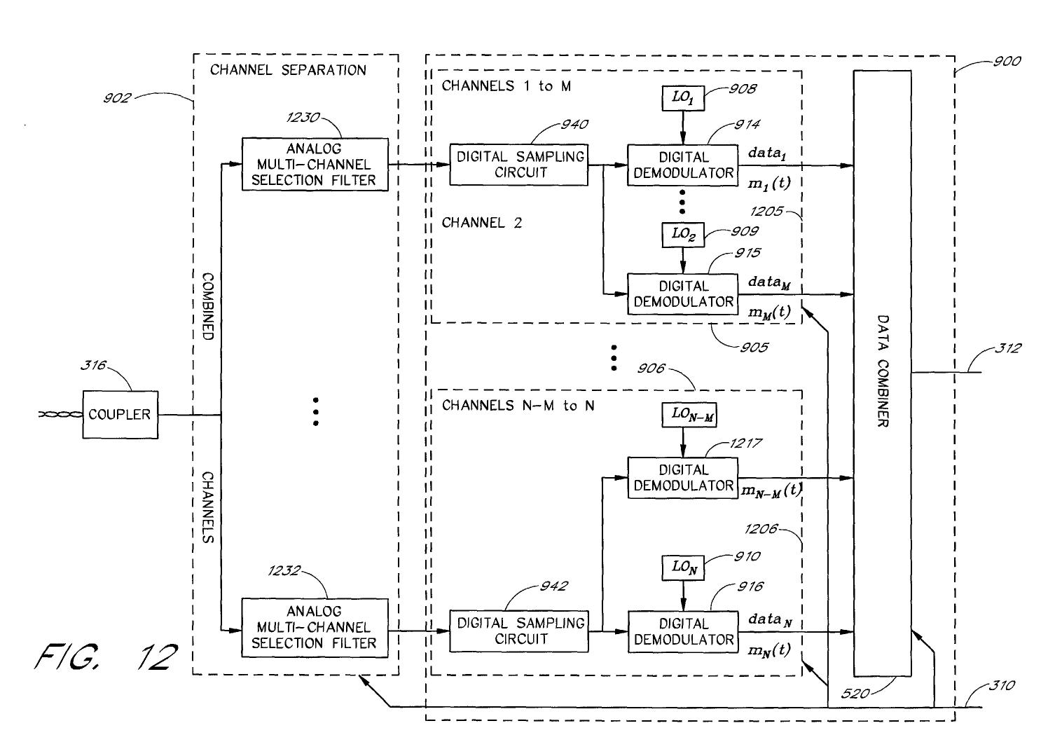

The control data 304 (i.e. control from a media access layer as described in connection with FIG. 13) is provided to control inputs of the data separator 420, the modulators 404-406, and the demultiplexer 402. In an alternative embodiment, the demultiplexer 402 is omitted, and four data input channels are provided, one data channel for each modulator.

The modulated signal outputs 441-443 are provided to modulated signal inputs of a combiner 420. A combined transmission signal from the combiner 420 is provided to a transmitter signal input of the AFE 316.

The transmitter 400 is a multi-channel frequency division multiplexed (FDM) system. N independent data channels are combined into a single transmission that is sent onto the powerline channel. Because the data streams 431-433 are independent, none, some, or all of the channels can be present at any given time. The data streams 431-433 can be synchronous with respect to each other, or asynchronous with respect to each other.

In one embodiment, the phase of each channel is random (uncorrelated) with respect to the phase of the other channels. This decorrelation reduces channel interference. The random phase also reduces the crest factor of the transmitter output signal by decorrelating the outputs. This insertion of a random phase in the data stream does not interfere with the data transmission, because the inserted phase shift is constant for each data packet, and the data in the packet is coded by phase transitions, not by absolute phase.

In the transmitter 400, N channels are combined for transmission. The modulators 404-406 can be configured to provide any suitable type of modulation, including, for example, Frequency Shift Key (FSK) modulation, Phase Shift Key (PSK) modulation, Quadrature Amplitude Modulation (QAM), etc. The modulated signals are then linearly combined by the combiner 420 and provided to the AFE 316.

The channel spacing between separate channels is determined by the frequencies of the local oscillators 408-410. The frequencies of the local oscillators 408 are chosen to provide the desired separation between channels. If the channels are not sufficiently separated, then the channels will interfere with each other. As with all FDM systems, one channel should not significantly interfere with any other channel. Some inter-channel interference is tolerable so long as the inter-channel interference is kept low enough to avoid excessive error rates in the transmitted data. The amount of inter-channel interference that can be tolerated depends, in part, on the modulation type and the desired maximum bit error rate. If the other channels cause an increase of bit error rate beyond the required maximum, then the channels may need to be separated further.

In one embodiment, the transmitter 400 uses Orthogonal FDM (OFDM). In OFDM, blocks of symbols are transmitted using orthogonal carriers. OFDM can be treated as independent modulation on separate carriers separated in frequency by at least 1/T (where T is the length in time of each orthogonal basis function, the orthogonal basis functions comprising a block of samples). Because the carriers are only separated by 1/T, there is significant spectral overlap between the channels. However, since the carriers are orthogonal, the overlap improves the overall spectral efficiency as compared to FDM. OFDM is also advantageous because all of the channels can be modulated together using a computationally efficient Fast Fourier Transform (FFT) or similar transform technique. In other words, the channel modulators 404-406 can be combined into a single block. Non-orthogonal FDM systems could also use a block transform method to simultaneously modulate all of the channels.

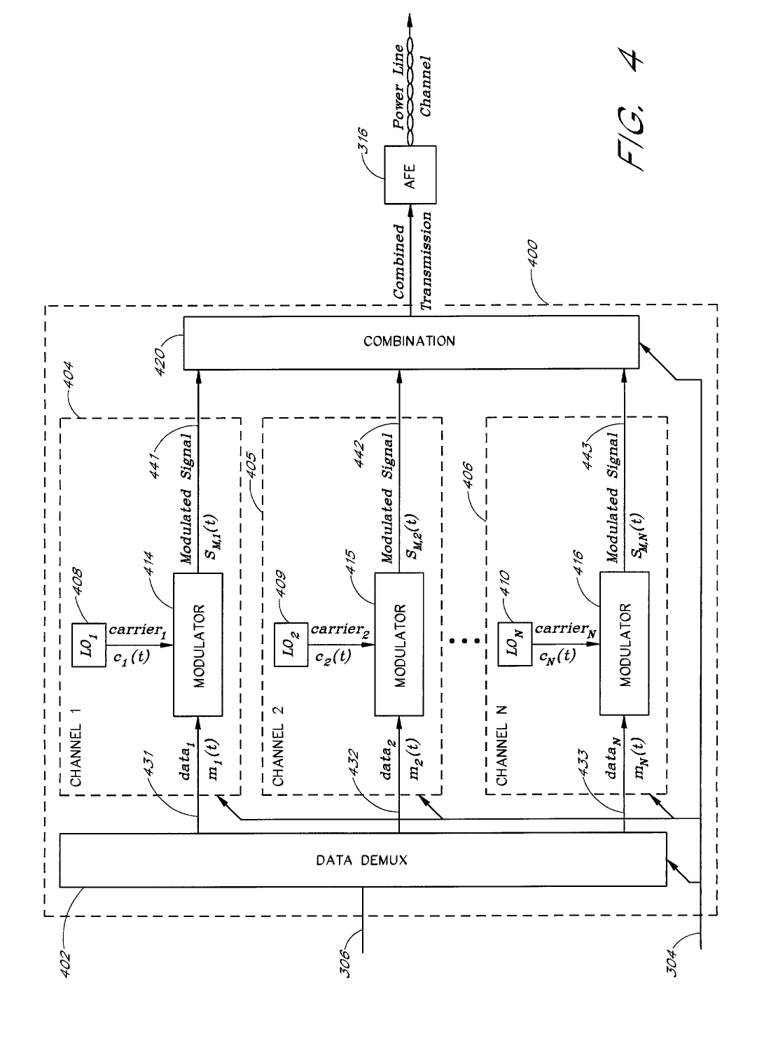

FIG. 5 is a block diagram of an N-channel receiver 500. The receiver 500 is one embodiment of the receiver 314 shown in FIG. 3. In the receiver 500, modulated data on the powerline is provided to the AFE 316. A combined channel output from the AFE 316 is provided to a combined channel input of a channel separator 502. A first channel output 531 from the channel separator 502 is provided to a modulated data input of a channel demodulator 504. A second channel output 532 from the channel separator 502 is provided to a data input of a channel demodulator 505. An N-th channel output 533 from the channel separator 502 is provided to a modulated data input of a channel demodulator 506.

The channel demodulator 504 includes a local oscillator 508 and a data demodulator 514. A carrier output from the local oscillator 508 is provided to a carrier input of the data demodulator 514. The modulated data 531 is provided to a data input of the data modulator 514. A data output 541 is provided by the data modulator 514 as an output of the channel demodulator 504.

The channel demodulator 505 includes a local oscillator 509 and a data demodulator 515. A carrier output from the local oscillator 509 is provided to a carrier input of the data demodulator 515. The modulated data 532 is provided to a data input of the data demodulator 515. A data output 542 is provided by the data demodulator 515 as an output of the channel demodulator 505.

The channel demodulator 506 includes a local oscillator 510 and a data demodulator 516. A carrier output from the local oscillator 510 is provided to a carrier input of the data demodulator 516. The modulated data 533 is provided to a data input of the data demodulator 516. A data output 543 is provided by the data modulator 516 as an output of the channel demodulator 506.

The demodulated signal outputs 541-543 are provided to data inputs of a data multiplexer 520. The combined data stream 312 is provided by an output from the multiplexer 520.

The control data 310 is provided to control inputs of the data multiplexer 520, the demodulators 504-506, and the channel separator 502.

The receiver 500 is configured to be compatible with the transmitter 400. As shown in FIG. 5, the channel separator 502 separates the channels, and then provides each channel to one of the demodulators 504-506 to be demodulated. Alternatively, the channel separator can be removed and each of the demodulators 504-506 can be configured to separate a desired channel as it demodulates.

In one embodiment, the channel separator 502 uses bandpass filters that select the correct frequencies corresponding to each channel. The bandpass filters can be analog or digital filters or a combination of analog and digital filters. In one embodiment, the channel separator 502 samples the data from the combined channels and performs a Fourier transform to separate the channels. The demodulators 504-506 can be coherent or incoherent demodulators.

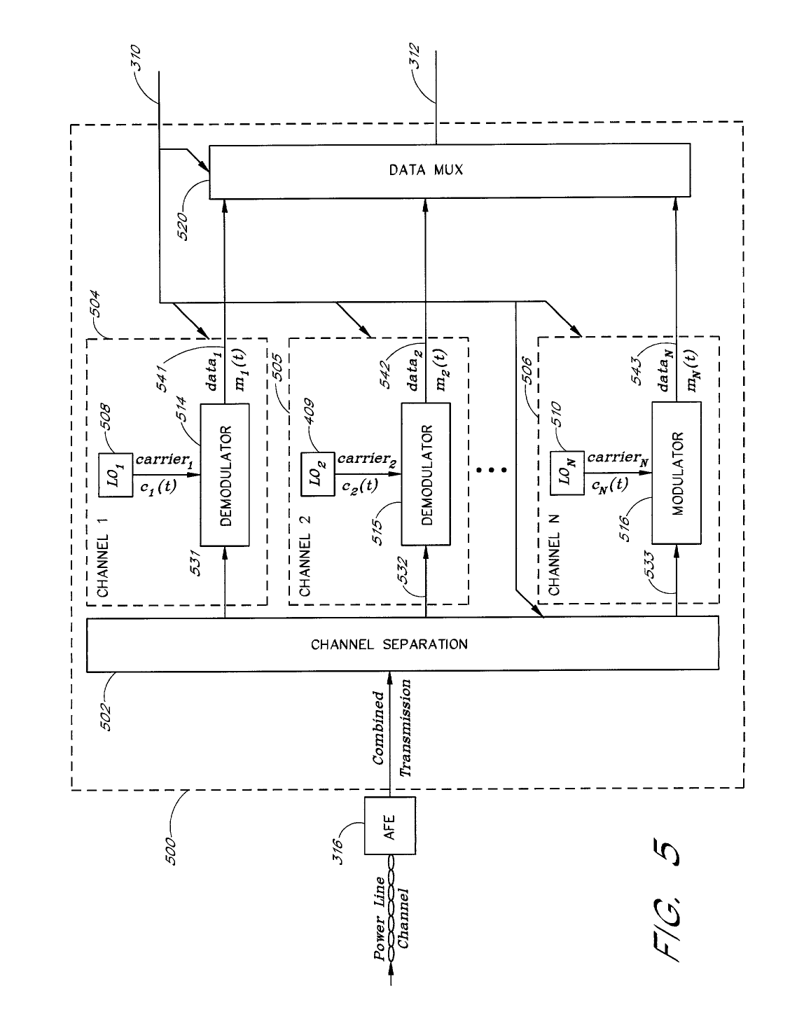

FIG. 6 is a block diagram of an N-channel transmitter 600 that uses Differential PSK (DPSK) modulation. The transmitter 600 is one embodiment of the transmitter 400 shown in FIG. 4. The transmitter 600 is similar to the transmitter 400, having the data demultiplexer 402, modulators 604-606 (corresponding to the modulators 405-406), and local oscillators 608-610 (corresponding to the local oscillators 408-410). The transmitter 600 provides DPSK modulators 614-616 (corresponding to the modulators 414-416) and a combiner (adder) 620 corresponding to the combiner 420. From communication theory, it is known that differential binary PSK (DBPSK) is very robust in low signal-to-noise situations. Due to this robust nature, DBPSK is used as the base signaling protocol.

The combiner 620 provides a linear combination of the channels using a simple addition of the discrete channels. Weighting each channel can also be used. The combined digital signals are provided to the AFE 316 where the digital signals are converted to the analog domain using a digital-to-analog converter (DAC) and a low-pass filter. The analog signal is then sent through a line driver for insertion into the powerline channel.

The modulators 614-616 are similar to each other, and thus, for simplicity, only the modulator 614 is described in detail. For the PSK modulator 614 the modulated signal, SM(t), is defined by:

S_{M}(t)=A cos (2πƒ_{c}t+βm(t)+Φ) (1)

In Equation 1, A is a scaling constant that will be ignored for the purposes of this discussion, β is the modulation index, and Φ is the phase at time t=0.

PSK is a digital modulation scheme, so m(t) can be rewritten as a sequence of values, m[n]. In other words, m(t) is a constant over the symbol time, Tₛ. Since m[n] is a bit sequence, it will have discrete values. BPSK uses two discrete values, typically m[n]ε{0, 1}. In BPSK, each symbol represents one bit. Quadrature PSK (QPSK) uses four discrete values, typically m[n]ε{0, 1, 2, 3}. In QPSK, each symbol represents two bits. In general, M-ary PSK (MPSK) uses M discrete values (a log₂(M) bit symbol), typically m[n]ε{0, 1, . . . , M−1}. To achieve maximum robustness, the distance between symbols should be maximized. In order to do achieve the maximum distance, m[n] typically needs to be uniformly spaced (i.e. m[n]εα({0, 1, . . . , M−1}+γ), for arbitrary (α and γ) and β needs to be 2π/Mα. With these modifications, the modulated signal becomes:

$${S}_{M} ( t , n ] = A cos ( 2 π {f}_{c} t + \frac{2 π}{M α} m [ n ] + ϕ ) \qquad ( 2 )$$

In order to reduce the need for an equalizer, differential PSK is used. With differential PSK, the data is encoded as the phase difference between the previous symbol and the current symbol, thus:

$${S}_{M} ( t , n ] = A cos ( 2 π {f}_{c} t + \frac{2 π}{M α} θ [ n ] + γ + ϕ ) , \\ θ [ n ] = g ( α \cdot ( f ( m [ n ] ) + θ [ n - 1 ] ) + γ ) \qquad ( 3 )$$

As shown in equation (3), either the first symbol (m[0]) is lost or there is a reference phase (θ[−1]). In one embodiment, α=1 and γ=0. In equation (3), ƒ(·) is a mapping of m[n]. In one embodiment ƒ(·) is a Gray mapping such that adjacent symbols represent a single-bit error, thereby reducing the probability of multi-bit errors. In equation (3), g(·) is a mapping of the result. In one embodiment, g(·) is a modulo operation to keep θ[n] in the range {0. . . N−1}.

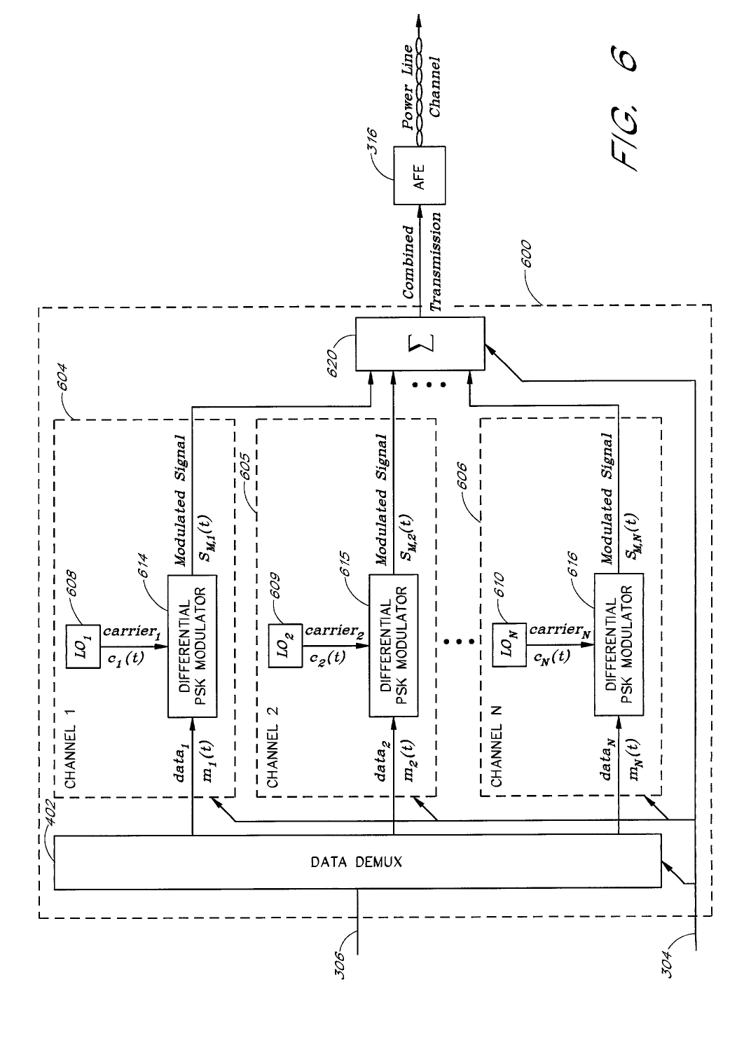

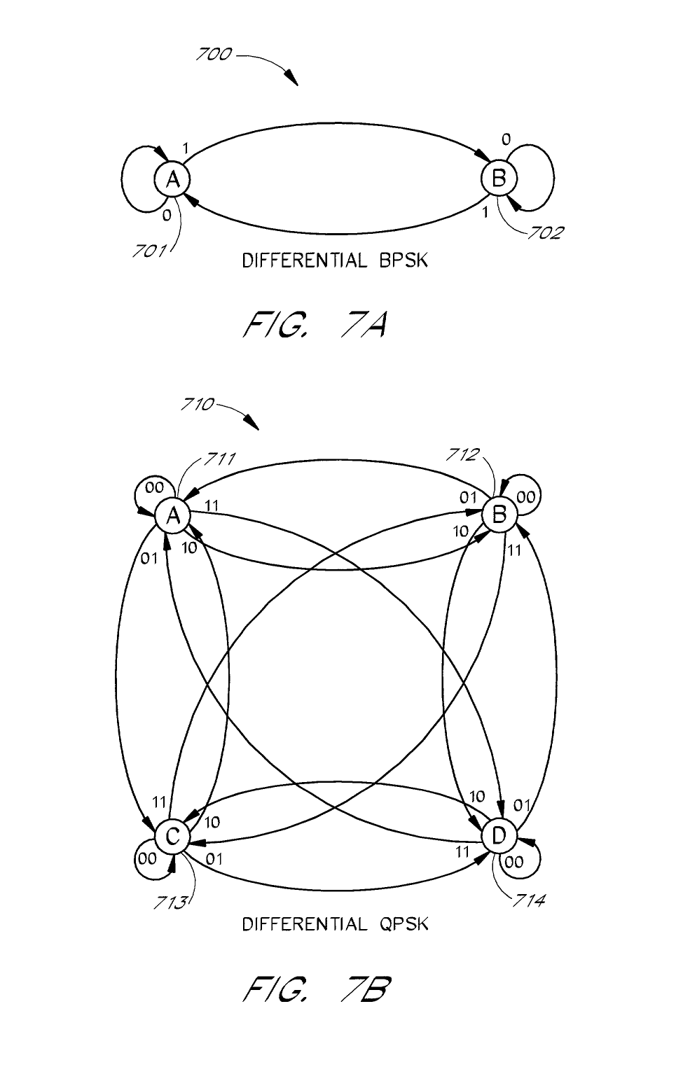

FIG. 7A is a state diagram for DBPSK modulation, including a state A_{b} 701 and a state B_{b} 702. State transitions are given as follows:

| From State | To State | On |
|---|---|---|
| A_{b} | A_{b} | 0 |
| A_{b} | B_{b} | 1 |
| B_{b} | A_{b} | 1 |
| B_{b} | B_{b} | 0 |

FIG. 7B is a state diagram for DQPSK modulation, including a state A_{q} 711, a state B_{q} 712, a state C_{q} 713, and a state D_{q} 714. State transitions from a first state to a second state are given as follows (where the row represents the “from” state, the column represents the “to” state, and the data in a cell represents the data that causes the transition):

| | A_{q} | B_{q} | C_{q} | D_{q} |
|---|---|---|---|---|
| A_{q} | 00 | 10 | 01 | 11 |
| B_{q} | 01 | 00 | 11 | 10 |
| C_{q} | 10 | 11 | 00 | 01 |
| D_{q} | 11 | 01 | 10 | 00 |

Referring to FIG. 7B, in a transmitter using DQPSK, if the initial state is B_{q} 712 and the next two bits are 10 then the next state will be D_{q} 714. In other words, the information is encoded in the state transition and not the state itself. Because the information is encoded in the transition, an initial state is required. The initial state may be arbitrarily set because the state contains no information.

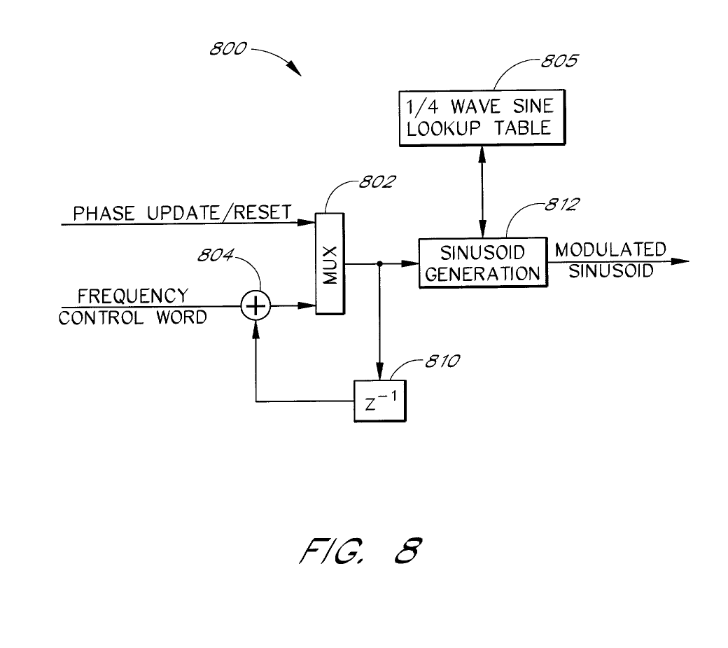

In order to generate the differential PSK signal, any method can be used. In one embodiment, a lookup table method is used. A sinusoid is generated by stepping through a quarter-wave lookup table. When a phase shift occurs, the phase is reset to the correct position. FIG. 8 is a block diagram of a digital DPSK modulator 800. A modulator input is provided to a first input of a multiplexer 802. An output of the multiplexer 802 is provided to an input of a sinusoid generator 812 and to an input of a one-symbol delay 810. An output of the one-symbol delay 810 is provided to a first input of an adder 804. A frequency control word (i.e. an increment value) is provided to a second input of the adder 804. An output of the adder 804 is provided to a second input of the multiplexer 802.

An address (phase) output from the sinusoid generator 812 is provided to an address (phase) input of a quarter-wave sinewave lookup table 805. An output of the sinewave lookup table 805 is provided to a data input of the sinusoid generator 812. An output of the sinusoid generator 812 is provided as a modulated sinusoid output of the modulator 800. The lookup table 805 returns a first-quadrant (0-90 deg.) value of a sine function in response to an address, thus the address corresponds to a scaled phase value. In other words, the lookup table returns a value x=sin(ka), where a is the address and k is a scale factor that converts the address into a phase.

In one embodiment, the sinusoid generator 812 constructs a full-wave sinusoid output from the quarter-wave lookup table using unsigned arithmetic based on an n-bit word length, wherein a 0 represents the smallest number and a word containing a one in all n-bits represents the largest value. The quarter-wave lookup table provides sinewave lookup values for the first quadrant (0-90 deg.). The sinewave generator 812 generates values for the second quadrant (90-180 deg.) by time reversal. Time reversal is accomplished by computing a new lookup-table address aᵣ. Expressed mathematically, aᵣ=180 k−a, where a is the original address. Expressed digitally, time-reversal can be accomplished by bit-by-bit negation (logical “not”) of the address bits provided to the lookup table 805. The sinewave generator 812 generates values for the third quadrant (180-270 deg.) by inverting bit-by-bit (the logical “not” function) the output data from the table 805. The sinewave generator 812 generates values for the fourth quadrant (270-360 deg.) by time reversal of the address bits and inversion of the output data. The use of unsigned arithmetic is advantageously used with digital-to-analog converters that do not recognize a sign bit.

In one embodiment, the length of the basis function is 128 samples clocked at 40.28 MHz.

Based on the clocking frequency and the number of points in the table 805, one can create a discrete set of frequencies to use for modulation. To minimize transmit hardware, both the clock frequency (sample rate SR) and the table size (N/4) should be as small as possible. The maximum frequency is (SR/2) and the minimum frequency spacing is SR/N. Given those constraints, the sample rate and the table size can be chosen intelligently.

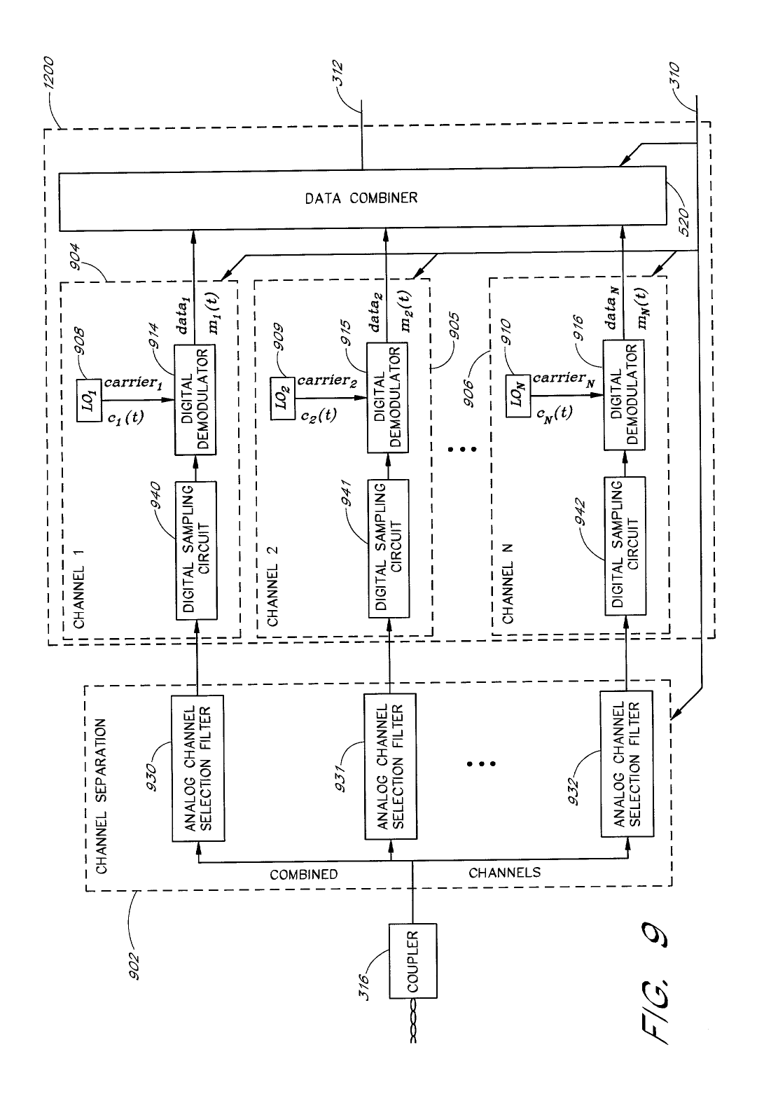

FIG. 9 is a block diagram of a digital N-channel receiver 900. The receiver 900 is one embodiment of the receiver 500 shown in FIG. 5. The receiver 900 is similar to the receiver 500, having a channel separator 902 (corresponding to the channel separator 502), channel demodulators 904-906 (corresponding to the demodulators 504-506), and local oscillators 908-910 (corresponding to the local oscillators 508-510). The channel demodulators 904-906 each include a digital sampler (digital samplers 940-942 respectively) and a digital demodulator (demodulators 914-916 respectively). The receiver 900 also provides the data multiplexer 520. The AFE 316 comprises a coupler 916 and the channel separator 902.

The channel separator includes bandpass filters 930-932. The combined channel signal from the coupler 916 is provided to an input of the bandpass filter 930, to an input of the bandpass filter 931 and to an input of the bandpass filter 932. An output of the bandpass filter 930 is provided to an input of the digital sampler 940. An output of the digital sampler 940 is provided to a modulated data input of the digital demodulator 914. An output of the bandpass filter 931 is provided to an input of the digital sampler 941. An output of the digital sampler 941 is provided to a modulated data input of the digital demodulator 915. An output of the bandpass filter 932 is provided to an input of the digital sampler 942. An output of the digital sampler 942 is provided to a modulated data input of the digital demodulator 916. Data outputs from the demodulators 914-916 are provided to data inputs of the data multiplexer 520.

The receiver 900 splits the received signal into separate channels, allowing each channel to be independent. Due to the nature of the powerline media, it is possible to lose (meaning the error rate is too high for reliable communications) one or more channels. The presented structure emphasizes the independence of each channel. Each analog filter 930-932 is designed to select an individual channel. The output of each bandpass filter 930-932 is band limited to a single channel. Other implementations can provide a smaller amount of analog separation by separating the channels using digital signal processing, using, for example, digital filters, Fourier transform processing, etc.

In one embodiment, the digital sampling circuits 940-942 are moved into the channel separator 316. In one embodiment, digital filters are inserted between the outputs of the digital sampling circuits 940-942 and the inputs of the digital demodulators 914-916. The inserted digital filters provide additional filtering to further reduce the effects of inter-channel interference.

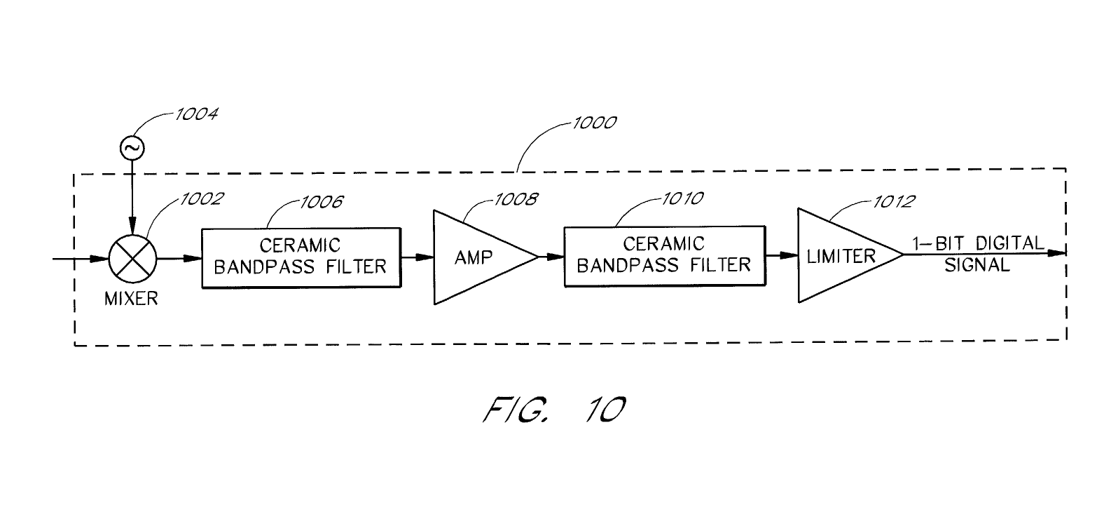

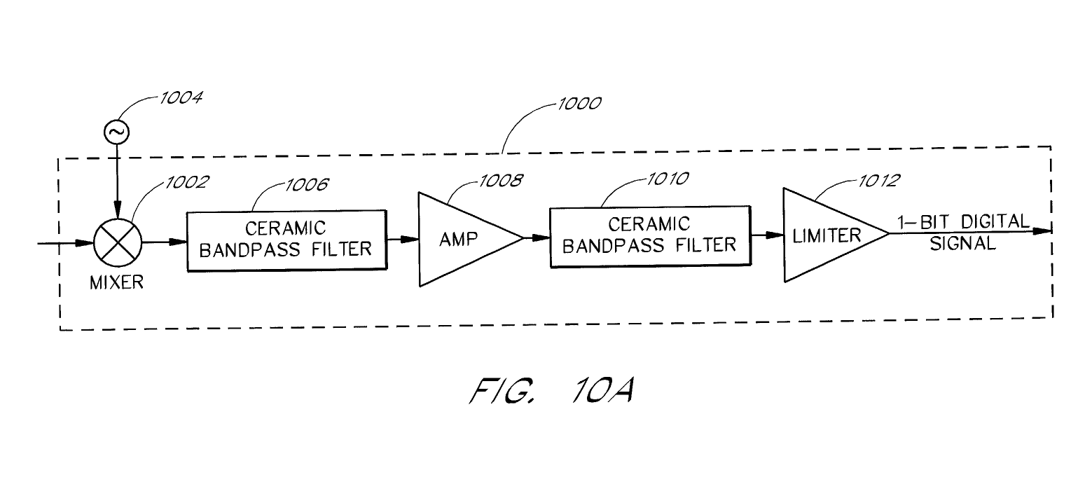

FIG. 10A is a block diagram of a 1-bit digital sampler 1000. The digital sampler 1000 is one embodiment of the digital samplers 940-942. An analog input to the digital sampler 1000 is provided to a first input of a mixer 1002. An output from an Intermediate Frequency (IF) rate generator 1004 is provided to a second input of the mixer 1002. An output from the mixer 1002 is provided to an input of a bandpass filter 1006. An output from the bandpass filter 1006 is provided to an input of an amplifier 1008. An output from the amplifier 1008 is provided to an input of a bandpass filter 1010. An output from the bandpass filter 1010 is provided to an input of a limiter 1012. An output from the limiter 1012 is a 1-bit digital signal.

Alternatively, the digital sampler 1000 can be configured as an n-bit sampler by configuring the limiter 1012 as an n-bit limiter. For example, a 2-bit system is shown in FIG. 10B.

The digital sampler 1000 takes the band-limited analog signal input and converts it to the digital domain and outputs a 1-bit stream. System cost is reduced through the use of standard, readily available parts components used in RF circuits. The sampler 1000 uses such RF components.

In order to leverage the inexpensive RF circuits, the band-limited signal is mixed to an intermediate frequency (IF) of 10.7 MHz generated by the local oscillator 1004. Ceramic bandpass filters 1006 and 1010 are used to attenuate the images and further attenuate out-of-band energy. Once the signal is band-limited to the frequency of interest, it is run through the limiting amplifier 1012 and the comparator 1012 to produce a 1-bit digital signal.

The 1-bit digital signal is used because it reduces the complexity of the digital hardware. Other implementations can use more bits. Usually more bits are exchanged for less stringent requirements on channel separation.

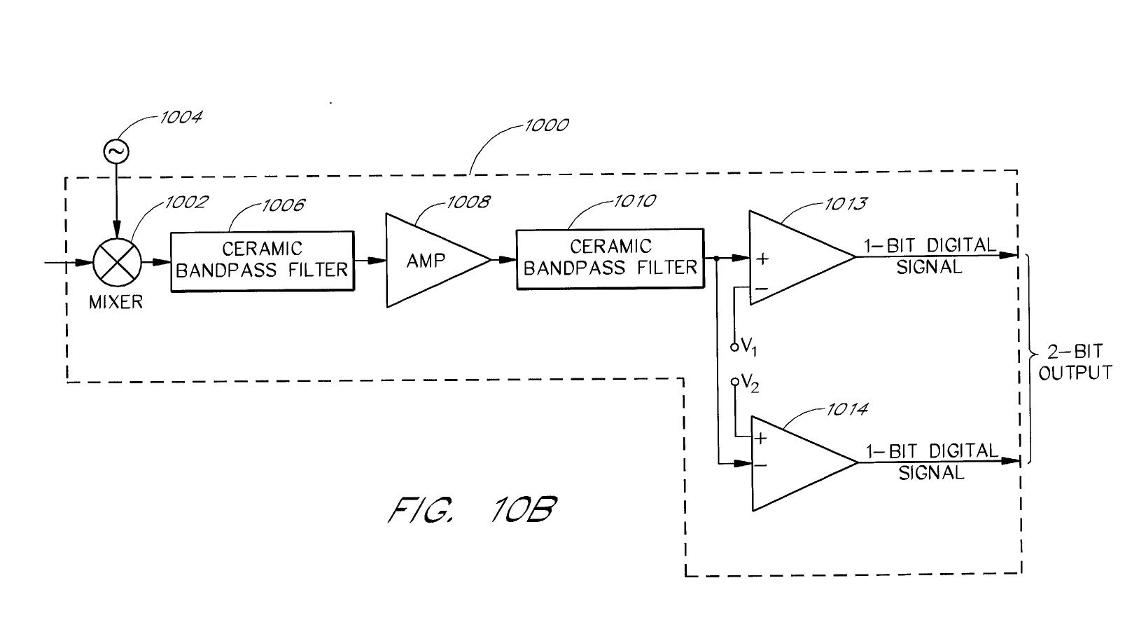

FIG. 11 is a block diagram of a digital DBPSK or DQPSK demodulator 1100. The demodulator 1100 is one embodiment of the digital demodulators 914-916 shown in FIG. 9. In the demodulator 1100, an input bit stream is provided to an input of a decimating correlator 1102. An output of the correlator 1102 is provided to an input of a programmable one-symbol delay 1106. The delay 1106 is configured with a programmable time delay output and a fixed time delay output. The fixed time delay output is provided to a first (non-conjugating) input of a conjugate multiplier 1108. The variable time delay output is provided to a second (conjugating) input of the conjugate multiplier 1108. The time delay 1106 is configured as an N-tap delay line. The variable time delay is provided by selecting one of the output taps (the i-th tap). A symbol time input selects the i-th tap to correspond to a one-symbol delay. The fixed time delay is provided by selecting the N-th tap. An output of the conjugate multiplier 1108 is provided to a first input of a conjugate multiplier 1110. A phase-adjustment signal is provided to a second input of the conjugate multiplier 1110. An output of the conjugate multiplier 1110 is provided to a first input of an integrator 1112. An output of the integrator 1112 is provided to an input of a symbol synchronizer 1114 and to a data input of a symbol alignment shifter 1116. An output from the symbol synchronizer 1114 is provided to a control input of the symbol alignment shifter 1116. An output from the symbol alignment shifter 1118 is provided to an input of a decimator 1118. An output from the decimator 1118 is provided as a demodulated-data output from the demodulator 1100. The symbol time input controls the decimation rate provided by the decimator 1118.

The complex decimating correlator 1102 is used to extract the desired signal from the 1-bit sampled data. The desired signal is known to be sinusoidal at a certain Intermediate Frequency (IF), so the signal is correlated with a complex sinusoid at the IF.

In one embodiment, the correlator 1102 operates at the IF sample rate.

In an alternate embodiment, the correlator 1102 subsamples the IF signal. Subsampling the IF signal and using an aliased image allows the use of aliasing to reduce the IF to a lower rate. Subsampling introduces a small penalty in signal-to-noise ratio, but provides for increased computational efficiency.

The output of the correlator 1102 is complex, so both magnitude and phase information is available. The signal is then delayed by one symbol by the programmable delay 1106, and the phase difference is calculated by multiplying the current sample by the conjugate of the sample one symbol earlier (using the conjugate multiplier 1108). The use of a programmable delay 1106 allows the symbol time to be changed in order to optimize the channel data rate as a function of channel noise. For example, when the channel is relatively noisy, relatively longer symbol times are used. Longer symbol times produce lower data rates, but provide higher noise tolerance for a given error rate. When the channel is relatively less noisy, then shorter symbol times are used to provide correspondingly higher data rates. The phase of the output of the multiplier 1108 is the phase difference between the two samples. Other phase adjustments (due to mixer effects, DPSK shifts, etc.) are provided by the multiplier 1110. The output of the multiplier 1110 is integrated, synchronized, and decimated to determine the valid bits.

As stated above, the output of the correlator 1102 uses a complex sinusoid that is tuned to the frequency of interest. Equation 4 shows a general complex sinusoid.

$${e}^{j \frac{2 π nk}{N}} = cos ( \frac{2 π nk}{N} ) + j sin ( \frac{2 π nk}{N} ) \qquad ( 4 )$$

In Equation 4, N is related to the table length used in the transmitter table 805. N is the number of samples needed to sample one period of the fundamental frequency of the transmitted sinusoid. For a transmitter using a 40.28 MHz clock and a table length (N/4) of 32 samples, the period of the fundamental frequency of the transmitted sinusoid is 3.17 μs. The value n is the time variable and k is the frequency variable. The value to use for k is determined by multiplying the frequency of interest by N and then dividing by the receiver's sample rate SR. This formula is shown in Equation 5.

$$k = f \frac{N}{SR} \qquad ( 5 )$$

Using the correlator 1102 with the above complex sinusoid will select the frequency of interest and give the desired phase and magnitude information.

Since the output of the correlator 1102 is band limited, the signal can be decimated significantly. In one embodiment, the largest value for decimation that leaves integers for both the number of samples in a symbol (5) and the number of samples required for one period of the fundamental frequency of the transmitter (4) is chosen. Another embodiment uses less decimation for better time resolution so symbol boundaries can be more accurately determined.

The one symbol delay 1106 is used to adjust for the change in phase from one symbol to the next. Delaying the samples by one symbol time is used by the receiver in determining the phase difference between symbols.

The change of phase is calculated by multiplying the current sample by the conjugate of the sample one symbol earlier. This causes the phase reference to be zero, which means the phase difference is the phase of the multiplier output.

Due to mixing of the incoming signal, another phase correction is needed. In general, to optimally decode an MPSK signal a phase correction is needed. In the present embodiment, all phase corrections are performed by the conjugate multiplier

The integrator 1112 is used to smooth the detected phase differences. The integrator 1112, in conjunction with the symbol synchronizer 1114 and decimator 1118, converts the waveform to the data stream. For DBPSK, the bit is the sign bit of the real value. For DQPSK, the bits are retrieved from the sign bits of both the real and imaginary values.

The symbol synchronizer 1114 finds the best location to sample the integrator output. The symbol synchronizer 1114 finds that location and then provides the location to the symbol alignment block 1116.

In the illustrated embodiment, the data is sent through the channel in packets. In other words, a transmitter only transmits when it has data. In order to handle the packet nature, of the system each, packet is given a header or preamble. In the preamble there is a synchronization word that is known to all transmitters and receivers.

The symbol synchronization algorithm 1114 correlates the received, demodulated signal with a known pattern. When the synchronization pattern is present, the correlator will have a large peak. The position of the peak provides a reference for finding the best sampling point.

Symbol alignment is achieved by taking the output of the symbol synchronizer 1114 and using that to delay the incoming demodulated data stream. The delay allows the data to be retrieved by simply sampling the output at the correct rate.

To generate the data stream, the output of the symbol alignment block 1116 is decimated to the correct rate. In the illustrated embodiment with DBPSK modulation, only the sign bit of the real value is needed because negative values correspond to a 1 bit (sign bit is 1) and positive value correspond to a 0 bit (sign bit is 0). Similarly, for DQPSK modulation, the sign bits of both the real value and the imaginary value are required to recover the two bits.

In one embodiment, a DBPSK signal with an 11.92-μs symbol time is used by the transmitter. The signal is demodulated with the receiver programmed to expect a 3.97-μs DBPSK symbol. Accordingly, there will be three demodulated symbols for each transmitted symbol. If the frequencies are chosen properly, the first symbol of the three will be the desired symbol with two padded symbols of either 0 or 1. The receiver then correlates the demodulator output against a known sequence and looks for the peak using a Barker code (which is bit-based), to get a relatively high peak at correlation. The transmitted 11.92-μs DBPSK symbols are ‘0 0 1 0’. The frequencies are chosen so that when the signal is demodulated with a 3.97-μs demodulator, the padded state looks like a ‘1’. With that knowledge, it is possible to correlate the demodulator output with a matched filter that is looking for a waveform that corresponds to the bit pattern ‘0 1 1 0 1 1 1 1 1 0 1 1’. This entails looking for three and only three peaks separated by the proper distance.

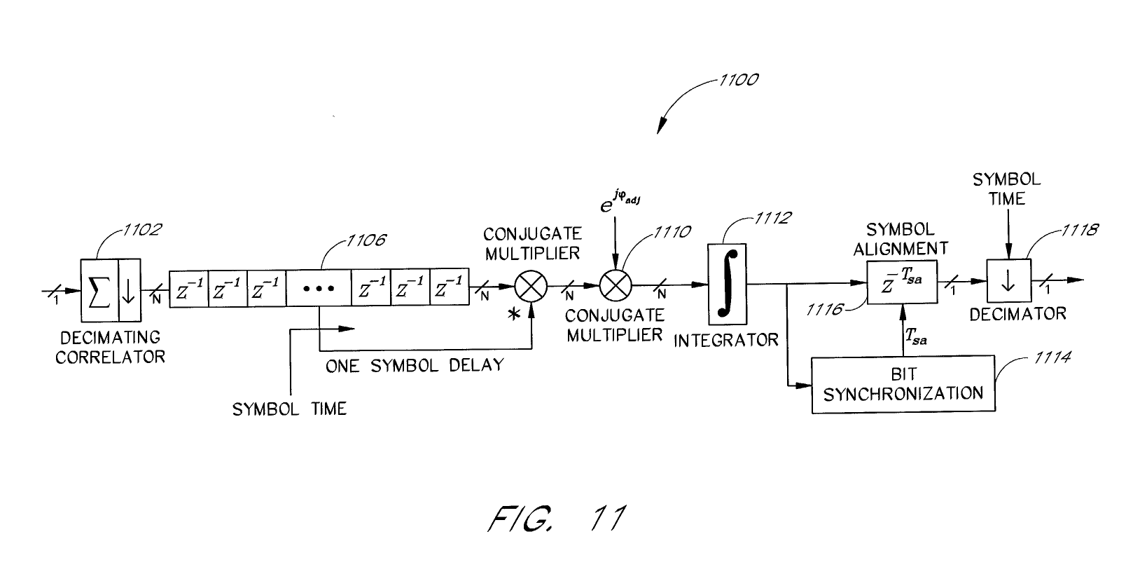

FIG. 12 is a block diagram of a digital N-channel receiver 1200 that separates and samples channels in groups (as compared with the receiver 900, which separates and samples channels individually). The receiver 1200 is one embodiment of the receiver 500 shown in FIG. 5. The receiver 1200 is similar to the receiver 900. The AFE 316 comprises a coupler 316 and the channel separator 902.

The channel separator includes bandpass filters 1230 and 1232. The combined channel signal from the coupler 316 is provided to an input of the bandpass filter 1230 and to an input of the bandpass filter 1232. The bandpass filter selects channels 1 through M and the bandpass filter 1232 selects channels N-M through N. Other bandpass (not shown) similarly select channels M+1 through N-M−1in groups of M channels. An output of the bandpass filter 1230 is provided to an input of the digital sampler 940. An output of the digital sampler 940 is provided to a modulated data input of the digital demodulator 914 and to a modulated data input of the digital demodulator 915. An output of the bandpass filter 1232 is provided to an input of the digital sampler 942. An output of the digital sampler 942 is provided to a modulated data input of the digital demodulator 916 and to a modulated data input of a digital demodulator 1217. Data outputs from the demodulators 914-916 and 1217 are provided to data inputs of the data multiplexer 520.

The receiver 1200 uses analog filtering to split the received signal into groups of channels. The groups of channels are then sampled and the sampled data is provided to digital demodulators where the channel signals are demodulated. In one embodiment, the digital demodulators 914-916 and 1217 include digital filters to select a desired channel, such that the output from each of the digital demodulators 914-916 and 1217 corresponds to a single channel (as in the receiver 900).

The receiver 1200 maintains the independence of each channel but requires fewer analog filters and fewer digital sampling circuits than the receiver 900. The analog filter 1230 and 1232 are designed to select a group of channels. Other implementations can provide a smaller amount of analog separation by separating the channels using digital signal processing, using, for example, digital filters, Fourier transform processing, etc.

In one embodiment, the bandpass filters 1230, 1232 (and the other bandpass filters for the channels M+1 through N-M−1are arranged in overlapping bands). In one embodiment, the bandpass filters 1230, 1232 (and the other bandpass filters for the channels M+1 through N-M−1are arranged in non-overlapping bands). In one embodiment, digital filters are inserted between the outputs of the digital sampling circuits 940, 942 and the inputs of the digital demodulators 914-916 and 1217. The inserted digital filters provide additional filtering to further reduce the effects of inter-channel interference.

FIG. 13 is a logical diagram showing the conceptual structure of a network system connecting a first computer 1301 and a second computer 1302. The first computer 1301 includes a network hardware layer 1308 (PHYsical layer or PHY) and a Media ACcess layer (MAC) 1305. The second computer includes a network hardware layer 1309 and a MAC 1306.

The hardware layers 1308 and 1309 communicate with each other through a group of one or more channels 1310. In the context of a powerline network system, the channels 1310 are carried by the powerline wiring in a building or small office. The computer 1301 sends data to the computer 1302 by providing the data to the MAC 1305. (One skilled in the art will recognize that many higher-level layers can sit on top of the MAC 1305 and the MAC 1306. These higher-level layers are not needed for the present discussion.) The MAC 1305 inserts the data as a data payload into a formatted data block (e.g., a packet, frame, etc) and passes the formatted block to the hardware layer 1308. The hardware layer 1308 modulates the formatted block and couples the modulated data onto the channels 1310. The channels carry the data along a network medium, such as, for example, a coax cable, a fiber optic cable, a telephone cable, a powerline, radio transmissions, etc.

Modulated data on the channels 1310 is received by the hardware layer 1309, demodulated, and passed to the MAC 1306. The MAC 1306 (or a higher layer above the MAC) extracts the data payload.

The MAC 1305 and the MAC 1306 typically cooperate to control the operation of the hardware layers 1308 and 1309. For example, in one embodiment, the hardware layer 1308 is implemented as a powerline network interface 300 shown in FIG. 3, and the MAC 1305 is implemented as software in the interface 302. The MAC 1305 sends data to the transmitter 308 via the data bus 306. The MAC 1305 receives data from the receiver 314 via the data bus 312. The MAC 1305 sends control information to the transmitter 308 using the control bus 304. The MAC 1305 also sends control information to the receiver 314 using the control bus 310. Using the control buses 304 and 310, the MAC 1305 controls the symbol times used by the transmitter 308 and receiver 314 to achieve a desired error performance.

The symbol times are selected by the MAC 1305 and 1306 because the hardware layers 1308 and 1309 are typically “blind” to the meaning of the data being transmitted and the error detection/correction bits in the data. In other words, the hardware layers 1308 and 1309 treat the data merely as a string of bits or symbols, and provides modulation and demodulation of the bits or symbols. The only data interpretation-type function typically performed by the hardware layers 1308 and 1309 is associated with the searching for synchronization patterns in the data, as described in connection with FIG. 11. By contrast, the MAC layers 1305 and 1306 are not blind to the data content and are thus able to examine CRC, FEC, and other error-type codes in the data to determine the error performance of each channel. Thus, the MAC layers 1305, 1306 are responsible for controlling the hardware layers 1308, 1309 in order to reduce errors while providing high throughput. In a non-OFDM system, the MAC layers 1305, 1306 can program each channel in the hardware layer 1308, 1309 independently (that is, each channel can have a different symbol time and data rate).

One skilled in the art will recognize that the layered structure shown in FIG. 13 is a conceptual model used for purposes of explanation, and that in practice the clean layered structure shown in FIG. 13 is sacrificed to improve performance, simplicity, etc. Thus, for example, an actual implementation can combine the function of the MAC layer and the physical layer into a single layer. Even when the MAC and physical layers are separate, the dividing line between them is often unclear, and various network functions can be considered to be in one or the other layer.

In one embodiment, the MAC layers 1305 and 1306 format the data into packets having up to a 64-byte payload. In one embodiment, each packet is less than 6 msec (milliseconds) long. Some devices such as light dimmers insert a short burst of noise on the powerline 120 times per second. In some circumstances, it is not possible to transmit data during these noise bursts. Nevertheless, the use of a less than 6 msec packet allows packets to be transmitted during the relatively quiet intervals between noise bursts.

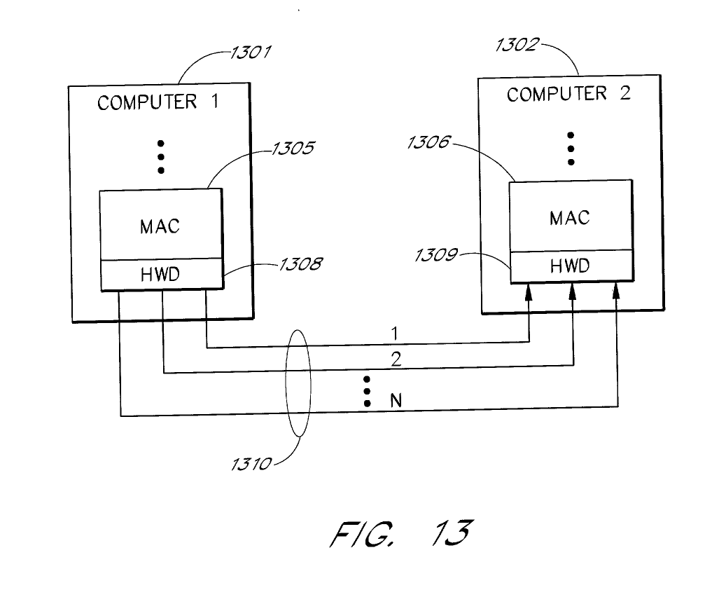

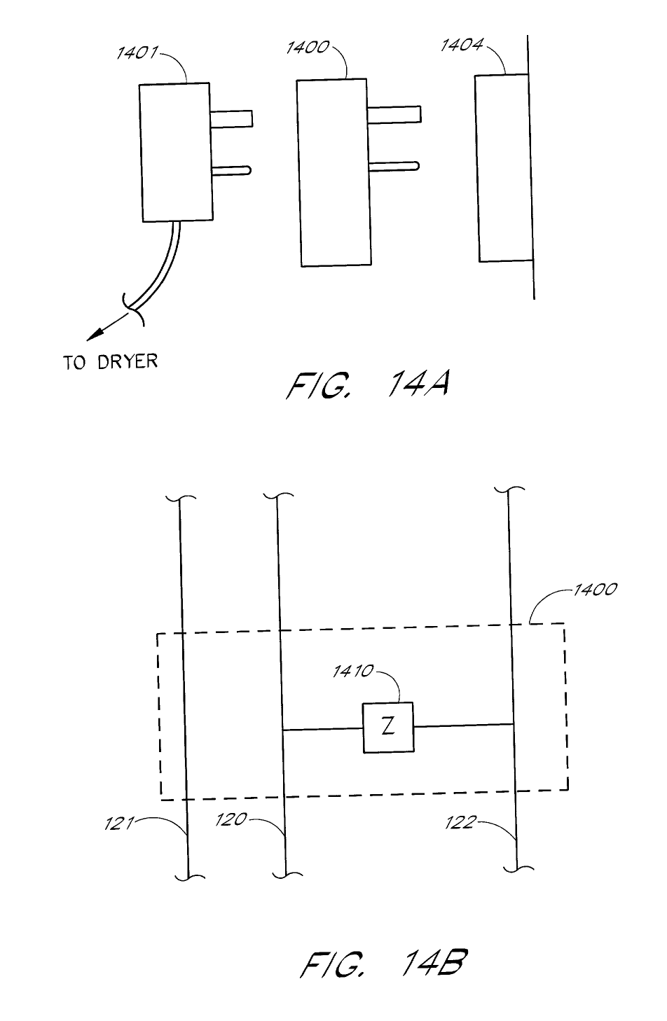

FIG. 14A is an illustration of a coupler 1400 for coupling data between different phases of a multi-phase power system, such as a two-phase 220-volt system used in most homes. The coupler 1400 plugs into a 220-volt outlet (e.g. a dryer outlet) 1404. The coupler 1400 also provides a 220-volt socket so that a 220-volt plug 1401 (e.g. from a dryer) can be plugged into the coupler 1400.

FIG. 14B is a schematic block diagram of the coupler 1400. As shown in FIG. 14B, the coupler operates as a pass-through device for the ground wire 121, the first hot wire 120 and the second hot wire 122. A first port of a two-port coupler 1410 is provided to the first hot wire 120, and a second port of the network 1410 is provided the second hot wire 122.

The coupler 1410 is configured to have a relatively high impedance at low frequencies (e.g. 60 Hz) and a relatively low impedance at high frequencies (e.g. above 500 kHz). In one embodiment, the coupler 1410 is implemented as a first-order high-pass filter (i.e. a capacitor). In one embodiment, the coupler 1410 is implemented is a higher-order filter. In one embodiment, the coupler 1410 includes a transformer.

Through the foregoing description and accompanying drawings, the present invention has been shown to have important advantages over current powerline networking systems. While the above detailed description has shown, described, and pointed out the fundamental novel features of the invention, it will be understood that various omissions and substitutions and changes in the form and details of the device illustrated may be made by those skilled in the art, without departing from the spirit of the invention. For example, the block diagrams of transmitters and receivers shown, for example, in FIGS. 4, 5, 6, 9 are drawn to emphasize the independence of each channel. In particular, the block diagrams show separate modulators and demodulators for each channel. One skilled in the art will realize, especially with (but not limited to) software implementations, the functions of modulating multiple channels or demodulating multiple channels can be provided by a single multi-channel functional block using, for example, Fourier transform processing, digital signal processing, and other numerical techniques. Therefore, the invention should be limited in its scope only by the following claims.

1. A powerline network physical layer that allows multiple nodes to exchange digital data at high speed, comprising:
a transceiver, said transceiver comprising:
a data separator configured to separate an input data stream into a plurality of channel data streams, said data separator further configured to produce channel control data for each of said channel data streams;
a plurality of modulators, each of said modulators configured to receive a received channel data stream and said channel control data corresponding to the received channel data stream, each modulator configured to produce a modulated data output; and
a combiner, said combiner configured to combine a plurality of said modulated data outputs to produce a combined transmission stream; and
an analog front end configured to couple said combined transmission stream onto a powerline, said analog front end further configured to; and
comprising:
receive signals from said powerline to produce a combined receive stream;
a channel separator configured to separate said combined receive stream into a plurality of channel streams;
a plurality of demodulators configured to demodulate said plurality of channel streams into a plurality of demodulated data streams, each demodulator configured to demodulate a single channel stream; and
a data combiner configured to combine said plurality of demodulated data streams into an output data stream.

2. The communication system of claim 1, wherein said physical layer provides point-to-point communication.

3. The communication system of claim 1, wherein said physical layer provides point-to-multipoint communication.

4. A powerline network transmitter comprising:
a data separator configured to separate an input data stream into a plurality of channel data streams, said data separator further configured to produce channel control data for each of said channel data streams;
a plurality of modulators, each of said modulators configured to modulate a selected channel data stream according to channel control data corresponding to said selected channel data, each modulator configured to produce a modulated data output; and
a combiner, said combiner configured to combine a said modulated data outputs to produce a combined transmission stream.

5. A communication system comprising a transmitter for sending data over a first communication channel carried by a communication medium, said transmitter configured to encode data for transmission over said channel using a first symbol time and a second symbol time, said first symbol time being relatively longer than said second symbol time, said first symbol time used during time periods when said first communication channel is more noisy, said second symbol time used during time periods when said communication channel is less noisy.

6. The communication system of claim 5, wherein said communication medium comprises a powerline.

7. The communication system of claim 5, wherein said communication medium comprisesis a coaxial cable.

8. The communication system of claim 5, wherein said communication channel medium is a radio frequency signal and said medium is air or vacuum.

9. The communication system of claim 5, wherein said communication medium comprises a twisted-pair cable.

10. The communication system of claim 5, wherein said communication medium comprises a fiber-optic cable.

11. The communication system of claim 5, wherein data is modulated onto said first channel using differential Binary Phase Shift Keying.

12. The communication system of claim 5, wherein data is modulated onto said first channel using differential Quadrature Phase Shift Keying.

13. The communication system of claim 5, wherein data is modulated onto said first channel using Quadrature Amplitude Modulation.

14. The communication system of claim 5, wherein data is modulated onto said first channel using Frequency Shift Keying.

15. The communication system of claim 5, further comprising a second channel carried by said medium, said transmitter further configured to use a third symbol time.

16. The communication system of claim 5, wherein said third symbol time is substantially equal to said first symbol time.

17. The communication system of claim 5, wherein said second channel is time-division multiplexed with said first channel.

18. The communication system of claim 5, wherein said second channel is frequency-division multiplexed with said first channel.

19. The communication system of claim 5, wherein said second channel is orthogonal frequency-division multiplexed with said first channel.

20. The communication system of claim 5, wherein said second channel is orthogonal frequency-division multiplexed with said first channel using a programmable block length.

21. The communication system of claim 5, wherein said second channel is aggregated with said first channel.

22. The communication system of claim 5, wherein a first error rate on said first channel is monitored and a second error rate on said second channel is monitored.

23. The communication system of claim 5, wherein a first error rate on said first channel is monitored and said first channel is disabled if said first error rate exceeds a specified value.

24. The communication system of claim 5, wherein said transmitter sends a first data stream on both said first channel and said second channel, and wherein a single-channel receiver receives said data stream by selecting either said first channel or said second channel.

25. The communication system of claim 5, wherein said first channel is uncorrelated with respect to said second channel.

26. The communication system of claim 5, wherein a phase of said first channel is uncorrelated with respect to said second channel.

27. The communication system of claim 5, wherein said first channel is correlated with respect to said second channel.

28. The communication system of claim 5, wherein a phase of said first channel is randomized with respect to said second channel.

29. The communication system of claim 5, wherein said first channel is synchronous with respect to said second channel.

30. The communication system of claim 5, wherein said first channel is asynchronous with respect to said second channel.

31. The communication system of claim 5, wherein said communication channel comprises a point-to-point channel.

32. The communication system of claim 5, wherein said communication channel comprises a point-to-multipoint channel.

33. The communication system of claim 5, wherein said communication channel comprises a point-to-point radio channel.

34. The communication system of claim 5, wherein said communication channel comprises a point-to-multipoint radio channel.

35. The communication system of claim 5, wherein said symbol is coded by phase transitions.

36. The communication system of claim 5, wherein a first symbol is used to energize said first channel.

37. A method for demodulating data for transmission on a noisy channel, comprising the steps of:
selecting a programmable symbol time;
using said symbol time to control a delay tap on a programmable delay;
using said symbol time to select a decimation rate of an output decimator;
providing a modulated signal to an input of said programmable delay; and
providing an output of said programmable delay to said output decimator.

38. A method for demodulating data comprising the steps of:
sub-sampling an intermediate frequency signal to produce an aliased image signal;
delaying said aliased image signal by a one symbol delay to produce a delayed image; and
calculating a phase difference by multiplying said aliased image signal by a complex conjugate said delayed image.

39. A method for symbol synchronization comprising the steps of:
receiving a received signal having a first symbol time;
demodulating said received signal using a second symbol time to produce a demodulator output;
correlating said demodulator output against a known symbol sequence and searching for a correlation peak; and
synchronizing using said correlation peak.

40. The method of claim 39, further comprising the steps of:
using a bit-based Barker code to provide a relatively high correlation peak.

41. A hunting receiver for receiving control information, said hunting receiver comprising a single-channel receiver configured to search for a desired signal on a plurality of channels by separately examining each channel of said plurality of channels, said single channel receiver configured to select a desired channel from said plurality of channels and receive data from said desired channel.

42. A method for sending data on a plurality of channels comprising the steps of:
selecting a first initial phase state for a first channel;
encoding data for modulation onto said first channel based on a phase difference between said first initial phase state and a second phase state;
selecting a second initial phase state for a second channel; and encoding data for modulation onto said second channel based on a phase difference between said second initial phase state and a third phase state.

43. An apparatus for communicating data over a noisy medium comprising:
means for modulating data onto at least one of a plurality of channels carried by said medium;
means for demodulating data received from a least one of said plurality of channels.

44. An apparatus for communicating data over powerlines comprising:
means for modulating data into at least one of a plurality of channels;
means for coupling said plurality of channels onto a powerline;
means for obtaining a first channel from said powerline; and
means for demodulating data from said first channel.

45. A digital demodulator comprising:
correlating means for autocorrelating a digital data stream to produce a correlated stream;
first decimating means for decimating said correlated stream to produce a decimated stream;
delaying means for producing a one-symbol delayed stream from said decimated stream; and
multiplying means for multiplying said correlated stream with a complex conjugate of said delayed stream to produce a phase-difference stream.

46. The digital demodulator of claim 45, further comprising:
phase shifting means for adjusting a phase of said phase-difference stream to produce a phase stream;
integrating means for integrating said phase stream;
synchronizing means for synchronizing said phase stream to produce synchronized stream; and
decimating means for decimating said synchronized stream to produce a bit stream.

47. The digital demodulator of claim 46, wherein said synchronizing means is programmable.

48. The digital demodulator of claim 46, wherein said synchronizing means synchronizes at symbol boundaries.

49. An apparatus for sending data from a first phase line of a powerline to a second phase line of the powerline, comprising:
means for plugging into a two-phase outlet of said powerline; and
means for coupling data from said first phase line to said second phase line.

50. An apparatus for sending data from a first phase of a powerline to a second phase of the powerline, comprising;
a plug configured to plug into a two-phase power outlet, said plug comprising a first prong configured to contact said first phase and a second prong configured to contact said second phase; and
a coupler comprising a first port and a second port, said first port provided to said first prong, and said second port provided to said second prong.

51. The apparatus of claim 50, wherein said coupler comprises a capacitor.

52. A method for demodulating data for transmission on a noisy channel wherein said noise is characterized by noise bursts separated by less noisy intervals, comprising the steps of:
selecting a programmable symbol time such that a packet comprising a desired number of symbols is shorter than an expected interval between noise bursts;
using said symbol time to control a delay tap on a programmable delay;
using said symbol time to select a decimation rate of an output decimator;
providing a modulated signal to an input of said programmable delay; and
providing an output of said programmable delay to said output decimator.

53. A computer power supply comprising a data coupler configured to provide a modulated signal onto a powerline.

54. A computer power supply comprising a data coupler configured to extract at least a portion of a modulated signal from a powerline.

55. A computer power supply comprising a powerline network interface, said power supply configured to provide one or more direct current voltages to a computer system, said powerline network interface comprising:
a first circuit configured to extract at least a portion of modulated data signal from a powerline; and
a second circuit configured to demodulate said modulated data signal.
